(19) United States
(12) Patent Application Publication
(10) Pub. No.: US 2012/0155360 A1
(43) Pub. Date: Jun. 21, 2012

(54) NEGATIVE-ACKNOWLEDGMENT ORIENTED RELIABLE MULTICAST OFFLOAD ENGINE ARCHITECTURE

(75) Inventors: Carl J. Peters, Pleasanton, CA (US); Agustinus Darmawan, San Jose, CA (US); James H. Galasso, JR., Devon, PA (US)

(73) Assignee: LOCKHEED MARTIN CORPORATION, Bethesda, MD (US)

(21) Appl. No.: 12/972,938

(22) Filed: Dec. 20, 2010

(51) Int. Cl. H04H 20/71; H04L 29/02

(52) U.S. Cl. 370/312; 370/466

(57) ABSTRACT

A device and method in which processing of NACK-Oriented Reliable Multicast (NORM) protocol data transmissions are offloaded from host processors. A NORM Offload Engine (NOE) software architecture may apply the NORM protocol within a Network Interface Card (NIC) or Network Blade (NB) hardware platform. Moving the NORM protocol processing from the host processor to the NOE hardware unit removes the protocol processing load from the host processor and significantly increases performance of data transmission among sources and sinks across a network layer.

### FIELD OF THE INVENTION

The present invention relates generally to communication of data over networks, and more particularly to offloading of data transmission protocol processing from a host processor.

### BACKGROUND OF THE INVENTION

A number of protocols exist for the transmission of data among various source devices and sink devices over data networks. Source devices and sink devices may take various forms including, for example, a computer server or collection of computer servers, a desktop computer, a laptop computer, a smart phone, a personal digital assistant, or the like. Source devices and sink devices may generally be referred to herein as sources and sinks Examples of protocols used in transmitting and receiving data over data networks include Transmission Control Protocol/Internet Protocol (TCP/IP), User Datagram Protocol (UDP), and File Transfer Protocol (FTP).

FIG. 1 depicts an exemplary prior art unicast TCP transmission of data. As shown in FIG. 1, there is a source 110 from which data is transmitted and a sink 120 that receives the data. A source transmitter 112 and a source receiver 114 are associated with the source 110 to enable transmission and reception of data streams to and from a network layer 130. A sink transmitter 122 and a sink receiver 124 are associated with the sink 120 to enable transmission and reception of signals to and from the network layer 130. A processor at the source 110 (the source processor) processes data in accordance with a TCP protocol for the transmitter 112 to transmit to the network layer 130 for delivery by the network layer 130 to the sink receiver 124. The sink receiver 124 directs the received data to a processor that is part of the sink 120 (the sink processor) for processing thereby in accordance with the TCP protocol. When called for by the TCP protocol, the processor at the sink 120 generates return data that is transmitted by the sink transmitter 122 to the network layer 130 for delivery by the network layer 130 to the source receiver 114. The source receiver 114 receives the return data and directs it to the processor of the source 110 for processing thereby in accordance with the TCP protocol. In addition to handling processing the transmitted and received data in accordance with a TCP protocol, the source and sink processors also handle processing of instructions relating to applications executing on the respective source 110 and sink 120 devices.

FIG. 2 depicts an exemplary prior art unicast UDP transmission of data. As shown in FIG. 2, there is a source 210 from which data is transmitted and a sink 220 that receives the data. A source transmitter 212 and a source receiver 214 are associated with the source 210 to enable transmission and reception of data streams to and from a network layer 230. A sink transmitter 222 and a sink receiver 224 are associated with the sink 220 to enable transmission and reception of signals to and from the network layer 230. A processor at the source 210 (the source processor) processes data in accordance with a UDP protocol for the transmitter 212 to transmit to the network layer 230 for delivery by the network layer 230 to the sink receiver 224. The sink receiver 224 directs the received data to a processor that is part of the sink 220 (the sink processor) for processing thereby in accordance with the UDP protocol. In addition to handling processing the transmitted and received data in accordance with a UDP protocol, the source and sink processors also handle processing of instructions relating to applications executing on the respective source 210 and sink 220 devices.

FIG. 3 depicts an exemplary prior art multicast UDP transmission of data. As shown in FIG. 3, there is a source 310 from which data is transmitted and a plurality of sinks 320A-320N that receive the data. A source transmitter 312 and a source receiver 314 are associated with the source 310 to enable transmission and reception of data streams to and from a network layer 330. Respective sink transmitters 322A-322N and sink receivers 324A-324N are associated with respective sinks 320A-320N to enable transmission and reception of signals to and from the network layer 330. A processor at the source 310 (the source processor) processes data in accordance with a UDP protocol for the transmitter 312 to transmit to the network layer 330 for delivery by the network layer 330 to the sink receivers 324A-324N. The respective sink receivers 324A-324N direct the received data to respective processors that are part of each respective sink 320A-320N (the sink processors) for processing thereby in accordance with the UDP protocol. In addition to handling processing the transmitted and received data in accordance with a UDP protocol, the source and sink processors also handle processing of instructions relating to applications executing on the respective source 310 and sink 320A-320N devices.

### SUMMARY OF THE INVENTION

Recently, another protocol referred to as Negative Acknowledgment Reliable Multicast (NORM) Transport Protocol has been developed. One example of the NORM protocol is specified in a document released for comment in November 2009 by the Naval Research Laboratory referred to as RFC 5740 and entitled “NACK-Oriented Reliable Multicast (NORM) Transport Protocol”, the entire disclosure of which is hereby incorporated by reference herein. As described therein, the NORM protocol provides end-to-end reliable transport of bulk data objects or stream over generic IP multicast routing and forwarding services.

While the NORM protocol can be implemented on the host processors of source and sink devices to handle NORM protocol data transmissions among the devices over a network layer, doing so requires the host processors of the source and sink devices to devote processing time to the NORM protocol data transmissions thereby reducing the amount of processing time available to execute applications on the source and sink devices. Accordingly, the present invention provides a system and method by which data transmission among source and sink devices over a network in accordance with the NORM protocol is facilitated by hardware units which offload the necessary NORM protocol processing operations from the host processors of the source and sink devices. The hardware unit may be referred to herein as a NORM Offload Engine (NOE) and the NOE may include an NOE software architecture that implements the NORM protocol.

The NOE software architecture may apply the Naval Research Laboratory NACK-Oriented Reliable Multicast (NORM) (RFC 5740) within a Network Interface Card (NIC) or Network Blade (NB) hardware platform. Moving the NORM protocol processing from the host processor to the hardware unit removes the protocol processing load from the host processor and significantly increases performance. Offloading the NORM protocol onto hardware based multi-core processors contained within a NIC or NB significantly increases the communications throughput and enables NORM to outperform host based unicast and multicast UDP or TCP protocols and TCP Offload Engines (TOE) such as shown in FIGS. 1, 2 and 3.

The NOE software architecture creates a very high speed, flexible and configurable network device that offloads protocol file based or data streams from the host processor and transmits them across LAN and/or WAN 10GE network infrastructures. The NOE may be architected to support full line rate of two 10GE interfaces or 40 Gbps bandwidth. The NOE software may be architected such that it can be applied to either network blades or workstation/server base NICs. The flexibility of the software architecture provides a powerful and flexible NOE device capable of surpassing existing TCP offload engines and satisfying numerous communications needs. The NOE can simultaneously operate across Local Area Networks (LAN) and/or Wide Area Networks (WAN) and support reliable unicast and/or multicast 10 giga-bit Ethernet data transmission. In addition, the NOE can implement the NORM Packet Forward Error Correction (PFEC) that can correct for lost packets without requiring additional network latency of requesting a re-transmission.

As such, the NOE replaces the UDP and TCP protocols and incorporates their best features. The NOE as defined in RFC 5740 provides reliable streaming or block transmissions similar to TCP and provides the multicasting features of UDP. An offloaded NORM protocol in a hardware accelerator provides a future for the high speed computers, operating systems and communications systems. The bottlenecks and delays caused by the standard TCP protocol stack will no longer be an issue for the networking infrastructures. The NOE provides network managers with a device that will improve overall communications across WANs and enable Forward Error Correction and reliable multicasting that can support very high data rates. The NOE can operate at the 10GE line rate with a much higher through put than other available protocol processors.

In one aspect, a networking device includes a hardware unit interposed between a host processor and a network layer. The hardware unit includes at least one processor. The processor may, for example, be a multi-core processor. The networking device also includes computer program instructions executable by the processor. In this regard, the hardware unit may include a memory on which at least a portion of the computer program instructions are stored until called for by the at least one processor of the hardware unit. The computer program instructions include, among other modules, a negative-acknowledgment oriented reliable multicast (NORM) stack module. When executed by the at least one processor of the hardware unit, the NORM stack module implements a NORM protocol specification to transmit and receive data between the network layer and the host processor.

In another aspect, a method for use in transmitting data between a host processor and a network layer includes the step of interposing a hardware unit in a communication path between the host processor and the network layer. In this regard, the hardware unit includes at least one processor which may, for example, be a multi-core processor. In another step of the method, the at least one processor of the hardware unit executes computer program instructions to implement a negative-acknowledgment oriented reliable multicast (NORM) stack module to transmit and receive data between the network layer and the host processor in accordance with a NORM protocol specification. In this regard, the method may also include the step of storing at least a portion of the computer program instructions on at least one memory included in the hardware unit.

Various refinements exist of the features noted in relation to the various aspects of the present invention. Further features may also be incorporated in the various aspects of the present invention. These refinements and additional features may exist individually or in any combination, and various features of the various aspects may be combined. These and other aspects and advantages of the present invention will be apparent upon review of the following Detailed Description when taken in conjunction with the accompanying figures.

### DESCRIPTION OF THE DRAWINGS

For a more complete understanding of the present invention and further advantages thereof, reference is now made to the following Detailed Description, taken in conjunction with the drawings, in which:

FIG. 1 depicts an exemplary prior art unicast TCP transmission of data among a source device and a sink device over a network layer;

FIG. 2 depicts an exemplary prior art unicast UDP transmission of data among a source device and a sink device over a network layer;

FIG. 3 depicts an exemplary prior art multicast UDP transmission of data among a source device and a plurality of sink devices over a network layer;

FIG. 4 depicts a unicast NORM transmission of data among a source device and a sink device over a network layer using NOEs at the source and sink;

FIG. 5 depicts a multicast NORM transmission of data among a source device and a sink device over a network layer using NOEs at the source and sinks;

FIG. 6 depicts one embodiment of a NOE hardware device;

FIG. 7 depicts one embodiment of an NOE software architecture that may be included in a NOE hardware device; and

FIG. 8 depicts the steps included in one embodiment of a method for use in transmitting data between a host processor and a network layer involving the use of a NOE hardware device.

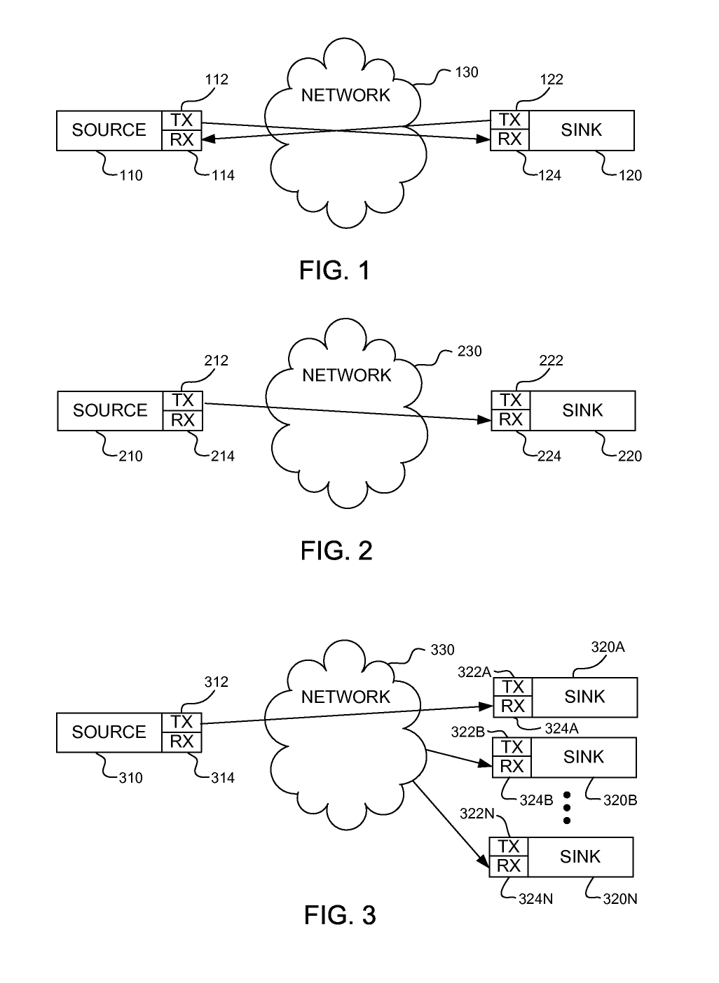

### DETAILED DESCRIPTION

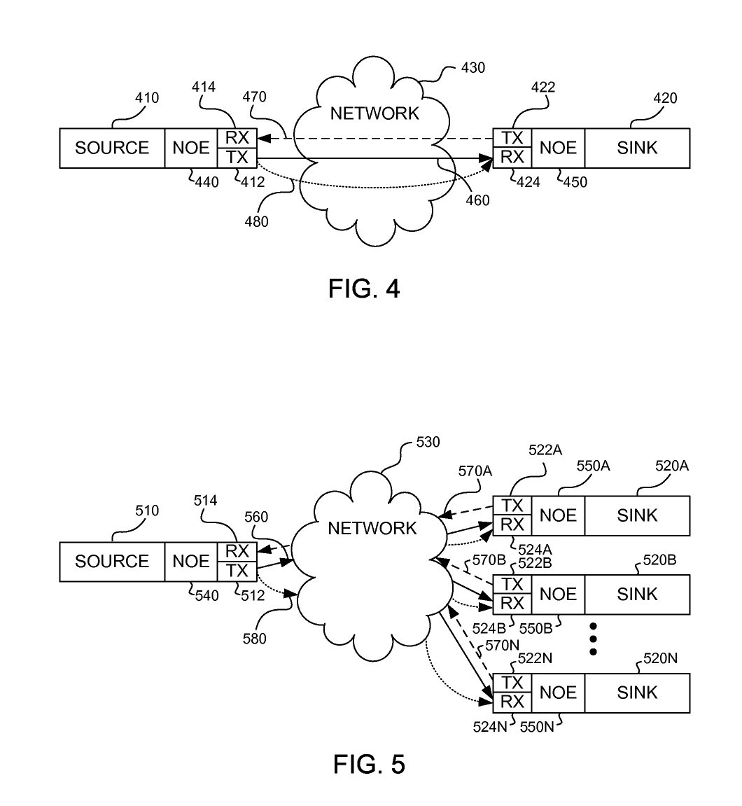

FIG. 4 depicts a unicast NORM transmission of data. As shown in FIG. 4, there is a single source 410 from which data is transmitted and a single sink 420 that receives the data. A source transmitter 412 and a source receiver 414 are associated with the source 410 to enable transmission and reception of data streams to and from a network layer 430. A sink transmitter 422 and a sink receiver 424 are associated with the sink 420 to enable transmission and reception of signals to and from a network layer 430. As shown, the network layer 430 may comprise a wide-area network (WAN), although in other instances, the network layer 430 may comprise a local-area network (LAN) or a combination of one or more WANs, one or more LANs, and/or other network configurations. As shown, the source transmitter and source receiver 412, 414 are indicated as separate devices and the sink transmitter and sink receiver 422, 424 are indicated as separate devices, although in other instances they may be combined into a single source transceiver and/or a single sink transceiver, respectively. Additionally, there may be a plurality of source transmitters/receivers/transceivers and/or a plurality of sink transmitters/receivers/transceivers where, for example, the source and/or sink has multiple network connections.

A NOE 440 is interposed between the source 410 and the source transmitter/source receiver 412/414. Another NOE 450 is also interposed between the sink 420 and the sink transmitter/sink receiver 422/424. The source-side NOE 440 processes a data stream 460 generated by the source 410 into a form consistent with the NORM protocol specification for transmission by the source transmitter 412 to the network layer 430 for delivery by the network layer 430 to the sink receiver 424. The sink-side NOE 450 processes the data stream 460 received by the sink receiver 424 in accordance with the NORM protocol specification. In this regard, the sink-side NOE 450 may deliver the processed data stream 460 to the sink 420. The sink-side NOE 450 may also generate a Negative Acknowledgment (NACK) 470 when called for in accordance with the NORM protocol specification. When generated, the NACK 470 is transmitted by the sink transmitter 422 to the network layer 430 for delivery by the network layer 430 to the source receiver 414. The source-side NOE 440 processes the NACK 470 received by the source receiver 414, and, when called for in accordance with the NORM protocol specification, generates a retransmitted data stream 480 for transmission by the source transmitter 412 to the network layer 430 for delivery by the network layer 430 to the sink receiver 424. When a retransmitted data stream 480 is received by the sink receiver 424, the sink-side NOE 450 process the retransmitted data stream 480 in accordance with the NORM protocol specification. In this regard, the sink-side NOE 450 may deliver the retransmitted data stream 480 to the sink 420 and may also generate a further NACK 470 if called for by the NORM protocol specification.

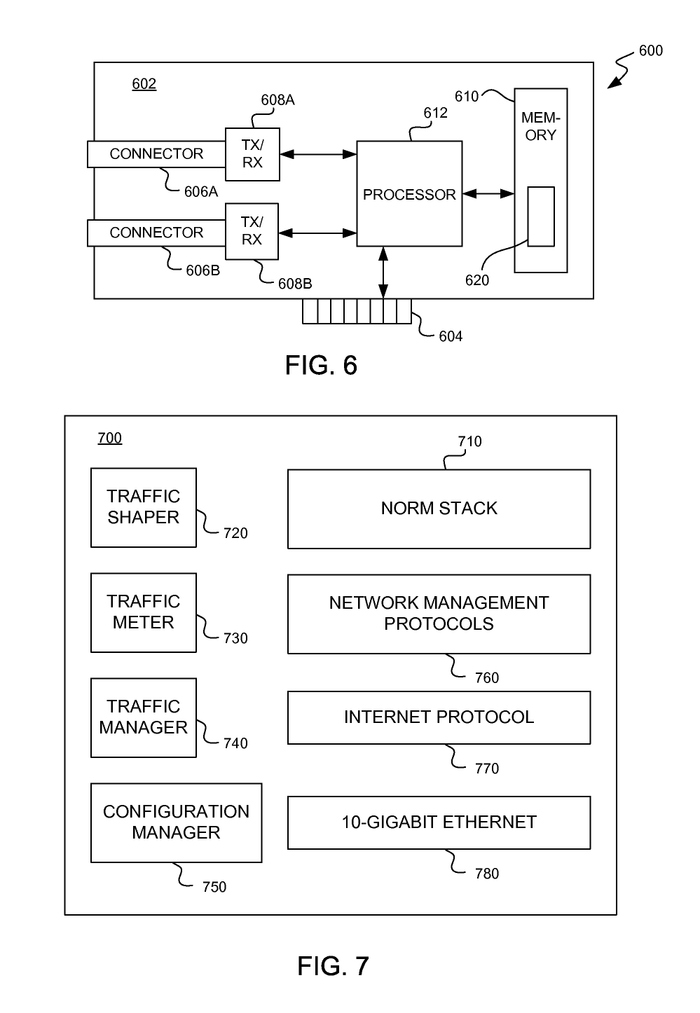

The source-side NOE 440 and sink-side NOE 450 may each comprise a separate NOE as described further herein in connection with FIG. 6. In this regard, the source-side NOE 440 may comprise, for example, a network blade device or a network interface card (NIC). The sink-side NOE 450 may likewise comprise, for example, a network blade device or a network interface card (NIC). Further, it is possible for the sink-side NOE 450 to function in the role of the source-side NOE 440 and for the source-side NOE 440 to function in the role of the sink-side NOE 450 depending upon the transmission direction of the data stream 460 (e.g., if the source 410 is the sink 420 and the sink 420 is the source 410).

FIG. 5 depicts a multicast NORM transmission of data. As shown in FIG. 5, there is a single source 510 from which data is transmitted to and a plurality of sinks 520A-520N that receive the data. A source transmitter 512 and a source receiver 514 are associated with the source 510 to enable transmission and reception of data streams to and from a network layer 530. Each sink 520A-520N has a respective sink transmitter 522A-522N and a respective sink receiver 524A-524N associated therewith to enable transmission and reception of signals to and from a network layer 530. As shown, the network layer 530 may comprise a wide-area network (WAN), although in other instances, the network layer 530 may comprise a local-area network (LAN) or a combination of one or more WANs, one or more LANs, and/or other network configurations. As shown, the source transmitter and source receiver 512, 514 are indicated as separate devices and each respective sink transmitter and sink receiver 522A-522N, 524A-524N are indicated as separate devices, although in other instances they may be combined into a single source transceiver and/or a single sink transceiver, respectively. Additionally, there may be a plurality of source transmitters/receivers/transceivers and/or a plurality of sink transmitters/receivers/transceivers at one or more of the sinks where, for example, the source and/or one or more of the sinks have multiple network connections.

A NOE 540 is interposed between the source 510 and the source transmitter/source receiver 512/514. Additional NOEs 550A-550N are also interposed between respective sinks 520A-520N and respective sink transmitters/sink receivers 522A-522N/524A-524N. The source-side NOE 540 processes a data stream 560 generated by the source 510 into a form consistent with the NORM protocol specification for transmission by the source transmitter 512 to the network layer 530 for delivery by the network layer 530 to the sink receivers 524A-524N. The sink-side NOEs 550 process the data stream 560 received by the respective sink receivers 524A-524N in accordance with the NORM protocol specification. In this regard, the sink-side NOEs 550A-550N may deliver the processed data stream 560 to the respective sinks 520A-520N. The sink-side NOEs 550 may also each generate a respective NACK 570A-570N when called for in accordance with the NORM protocol specification. When generated, respective NACKs 570A-570N are transmitted by the respective sink transmitters 522A-522N to the network layer 530 for delivery by the network layer 530 to the source receiver 514. The source-side NOE 540 processes the NACK 570 received by the source receiver 514, and, when called for in accordance with the NORM protocol specification, generates a retransmitted data stream 580 for transmission by the source transmitter 512 to the network layer 530 for delivery by the network layer 530 to the sink receivers 524A-524N. When a retransmitted data stream 580 is received by a respective sink receiver 524A-524N, the respective sink-side NOEs 550A-550N process the retransmitted data stream 580 in accordance with the NORM protocol specification. In this regard, the respective sink-side NOEs 550A-550N may deliver the retransmitted data stream 580 to the respective sinks 520A-520N and may also generate further respective NACKs 570A-570N, if called for by the NORM protocol specification.

The source-side NOE 540 and sink-side NOEs 550 may each comprise a separate NOE as described further herein in connection with FIG. 6. In this regard, the source-side NOE 540 may comprise, for example, a network blade device or a network interface card (NIC). The sink-side NOEs 550 may likewise each comprise, for example, network blade devices or network interface cards (NICs). Further, it is possible for one of the sink-side NOEs 550A-550N to function in the role of the source-side NOE 540 and for the source-side NOE 540 to function in the role of one of the sink-side NOEs 550A-550N depending upon the transmission direction of the data stream 560 (e.g., if the source 510 is one of the sinks 520A-520N and one of the sinks 520A-520N is the source 510).

FIG. 6 depicts one embodiment of a NOE hardware device 600. The NOE hardware device 600 is implemented in the form of a commercial off-the-shelf (COTS) PCIe NIC, although in other embodiments NOE hardware devices may be implemented in other COTS and non-COTS forms including, for example, a network blade. The NOE hardware device 600 includes a circuit board 602, a PCI slot connector 604, two network cable connectors 606A and 606B (e.g., RJ-45 jacks), two network communications transceivers 608A and 608B coupled to the respective network cable connectors 606A and 606B, a memory 610, and a processor 612. The processor 612 is communicatively coupled (e.g. via electrically conductive traces on the circuit board 602) with the PCI slot connector 604, the transceivers 608A and 608B, and the memory 610. The processor 612 may be a multi-core processor such as, for example, an OCTEON® COTS MIPS64 Multi-Core Intelligent Communications & Network Processor available from Cavium Networks of Mountain View, Calif. In other embodiments, the processor 612 may comprise one or more single-core processors, a plurality of multi-core processors, or a combination of one or more single-core processors and one or more multi-core processors. Additionally, the NOE hardware device may include one or more wireless network transceivers (not shown) and/or one or more optical network transceivers (not shown) communicatively coupled with the processor 612 for wireless transmission and/or electrical and/or optical transmission of data from/to the NOE hardware device 600.

The PCI slot connector 604 permits installation of the NOE hardware device 600 in a PCI slot of a source or sink device (e.g. a computer server). The processor 612 can thereby communicate with one or more processors in the source or sink device via a PCI system bus. Where the NOE hardware device comprises a network blade or other COTS and non-COTS form, the NOE hardware device 600 may include an appropriate type of connector communicatively coupled with the processor 612 to enable connection to source and sink devices and communication with one or more processors in the source or sink devices.

The NOE hardware device 600 includes computer program instructions executable by said processor 612. The computer program instructions may be referred to herein as the NOE integrated software application 620 or just the NOE application 620. The NOE application 620 may be stored on the memory 610 of the NOE hardware device 600 and loaded into the processor 612 as needed prior to and/or during execution by the processor 612. When executed by the processor 612, the NOE application 620 enables the processor 612 to process incoming data received from a network layer via the network cable connectors 606A-606B by the network communications transceivers 608A-608B in accordance with the NORM protocol specification. When executed by the processor 612, the NOE application 620 also enables the processor 612 to process outgoing data received from one or more source or sink host processors via PCI slot connector 604 in accordance with the NORM protocol specification for transmission by the transceivers 608A-608B to a network layer via the network cable connectors 606A-606B.

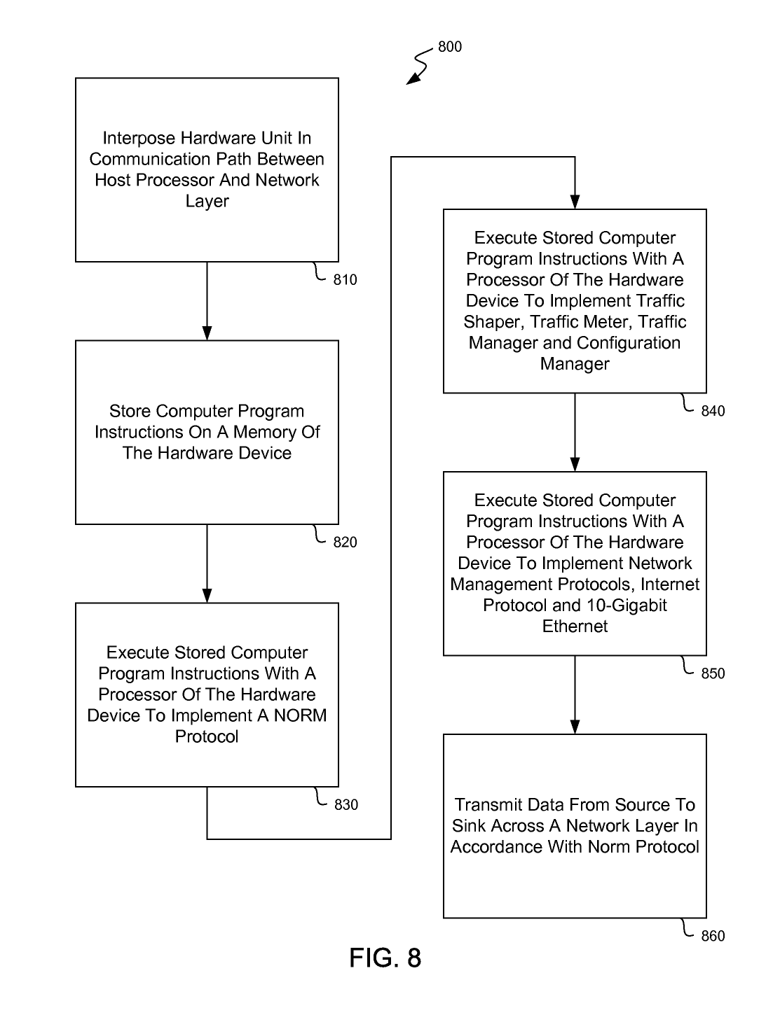

FIG. 7 shows one embodiment of a NOE software architecture 700 of a NOE application such as NOE application 620 of FIG. 6. The NOE software architecture 700 includes a NORM stack module 710, a traffic shaper module 720, a traffic meter module 730, a traffic manager module 740 and a configuration manager module 750, all of which are unique to the NOE software architecture 700. The NOE software architecture 700 may also include several COTS modules such as for example, a network management protocols module 760, an internet protocol module 770 and a 10-gigabit Ethernet module 780.

The NORM stack module 710 comprises computer program instructions executable by a processor such as processor 612 of the NOE hardware device 600 of FIG. 6. When executed, the instructions of the NORM stack module 710 enable the processor 612 to implement a NORM protocol specification such as, for example, a NORM protocol specification as specified in RFC 5740, to transmit and receive data between a network layer and one or more host processors of a source or sink device. The instructions comprising the NORM stack module 710 remain consistent from platform-to-platform (e.g. PCI NIC, network blade, etc.).

The traffic shaper module 720, traffic meter module 730, traffic manager module 740 and configuration manager module 750 comprise computer program instructions executable by a processor such as processor 612 of the NOE hardware device 600 of FIG. 6. When executed, the instructions of the traffic shaper module 720 enable the processor 612 to control bandwidth settings applicable to data transmissions from the hardware device 600. When executed, the instructions of the traffic meter module 740 enable the processor 612 to buffer incoming transmissions from the network layer and transmit to network at regular intervals. When executed, the instructions of the traffic manager module 750 enable the processor 612 to manage handling of incoming and outgoing data transmissions. When executed, the instructions of the configuration manager module 750 enable the processor 612 to set configuration settings of the hardware device 600. The instructions comprising the traffic shaper module 720, traffic meter module 730, traffic manager module 740 and configuration manager module 750 may vary from platform-to-platform (e.g. PCI NIC, network blade, etc.) to enable the NORM stack module 710 to remain consistent regardless of the platform on which it is executed.

The other COTS modules of the NOE software architecture 700 (the network management protocol module 760, internet protocol module 770 and a 10-gigabit Ethernet module 780) comprise computer program instructions executable by a processor such as processor 612 of the NOE hardware device 600 of FIG. 6. When executed, the instructions comprising the network management protocols module 760, internet protocol module 770 and a 10-gigabit Ethernet module 780 enable the processor 612 to handle necessary network management, receive and transmit data via internet protocol, and communicate via a 10-gigabit Ethernet connection to a network layer, respectively.

FIG. 8 shows steps included in one embodiment of a method 800 for transmitting data between a host processor of a sink or source and a network layer involving the use of a NOE hardware unit 600 such as shown in FIG. 6. In step 810, a hardware unit that includes at least one processor is interposed in a communication path between the host processor and the network layer. In this regard, the hardware unit may, for example, comprise a PCI NIC that is installed in an available PCI slot of a source or sink device having the host processor. In another exemplary embodiment, the hardware unit may, for example, comprise a network blade that is installed as part of a network blade source or sink device.

In step 820, computer program instructions are stored on at least one memory included in the hardware unit. In this regard, step 820 may be performed before and/or after step 810 in which the hardware unit is interposed in the communication pathway between the host processor and the network layer. In step 830, the computer program instructions are executed with the at least one processor of the hardware unit to implement a NORM stack module to transmit and receive data between the network layer and the host processor in accordance with a NORM protocol specification. In this regard, the computer program instructions included in the NORM stack module may implement packet forward error correction when executed by the at least on processor of the hardware unit. In step 840, the computer program instructions are executed with the at least one processor of the hardware unit to implement one or more modules that adapt the NORM module to the specific hardware unit and source or sink (e.g., a traffic shaper module, a traffic meter module, a traffic manager module, and/or a configuration manager module). In step 850, the computer program instructions are executed with the at least one processor of the hardware unit to implement one or more COTS modules (e.g., a 10-giga-bit Ethernet module, an internet protocol (IP) module, and/or a network management protocol module). In step 860, data is transmitted between the host processor and one or more sinks across the network layer in accordance with the NORM protocol specification.

While various embodiments of the present invention have been described in detail, further modifications and adaptations of the invention may occur to those skilled in the art. However, it is to be expressly understood that such modifications and adaptations are within the spirit and scope of the present invention.

What is claimed is:

1. A networking device comprising:
a hardware unit interposed between a host processor and a network layer, the hardware unit including at least one processor; and
computer program instructions executable by said processor, said computer program instructions including a negative-acknowledgment oriented reliable multicast (NORM) stack module, wherein said NORM stack module implements a NORM protocol specification to transmit and receive data between the network layer and the host processor.

2. The device of claim 1 further comprising at least one memory included in the hardware unit, the memory storing at least a portion of the computer program instructions.

3. The device of claim 1 wherein said at least one processor comprises a multi-core processor.

4. The device of claim 1 wherein said hardware unit comprises a network blade.

5. The device of claim 1 wherein said hardware unit comprises a network interface card.

6. The device of claim 1 wherein the NORM stack module simultaneously supports unicast transmission and multicast transmission.

7. The device of claim 1 wherein the NORM stack module implements packet forward error correction.

8. The device of claim 1 wherein the network layer comprises at least one of a wide area network (WAN) and a local area network (LAN).

9. The device of claim 1 wherein said computer program instructions executable by said processor further include at least one of a 10-giga-bit Ethernet module, an internet protocol (IP) module, and a network management protocol module.

10. The device of claim 1 wherein said computer program instructions executable by said processor further include at least one of a traffic shaper module, a traffic meter module, a traffic manager module, and a configuration manager module.

11. A method for use in transmitting data between a host processor and a network layer, said method comprising:
interposing a hardware unit in a communication path between the host processor and the network layer, the hardware unit including at least one processor; and
executing computer program instructions with the at least one processor of the hardware unit to implement a negative-acknowledgment oriented reliable multicast (NORM) stack module to transmit and receive data between the network layer and the host processor in accordance with a NORM protocol specification.

12. The method of claim 11 further comprising:
storing at least a portion of the computer program instructions on at least one memory included in the hardware unit.

13. The method of claim 11 wherein, in said step of executing, the at least one processor of the hardware unit comprises a multi-core processor.

14. The method of claim 11 wherein, in said step of disposing, the hardware unit comprises a network blade.

15. The method of claim 11 wherein, in said step of disposing, the hardware unit comprises a network interface card.

16. The method of claim 11 further comprising:
transmitting data between the host processor and a single sink across the network layer in accordance with the NORM protocol specification.

17. The method of claim 16 wherein, in said step of transmitting, the network layer comprises at least one of a wide area network (WAN) and a local area network (LAN).

18. The method of claim 11 further comprising:
transmitting data between the host processor and a plurality of sinks across the network layer in accordance with the NORM protocol specification.

19. The method of claim 18 wherein, in said step of transmitting, the network layer comprises at least one of a wide area network (WAN) and a local area network (LAN).

20. The method of claim 11 further comprising:
executing computer program instructions included in the NORM stack module to implement packet forward error correction.

21. The method of claim 11 further comprising:
executing computer program instructions with the at least one processor of the hardware unit to implement at least one of a 10-giga-bit Ethernet module, an internet protocol (IP) module, and a network management protocol module.

22. The method of claim 11 further comprising:
executing computer program instructions with the at least one processor of the hardware unit to implement at least one of a traffic shaper module, a traffic meter module, a traffic manager module, and a configuration manager module.
